(19) United States
(12) Patent Application Publication
(10) Pub. No.: US 2022/0309091 A1
(43) Pub. Date: Sep. 29, 2022

(54) VERIFYING AND CORRECTING TEXT PRESENTED IN COMPUTER BASED AUDIOVISUAL PRESENTATIONS

(71) Applicant: International Business Machines Corporation, Armonk, NY (US)

(72) Inventors: Ravi Prakash Bansal, Tampa, FL (US); Swaminathan Balasubramanian, Troy, MI (US); Sarbajit K. Rakshit, Kolkata (IN); Pierre C. Berlandier, San Diego, CA (US)

(21) Appl. No.: 17/215,024

(22) Filed: Mar. 29, 2021

(51) Int. Cl. G06F 16/483; G11B 27/031; G10L 15/26; G06F 40/295

(52) U.S. Cl. CPC G06F 16/483; G11B 27/031; G10L 15/26; G06F 40/295

(57) ABSTRACT

Technology for taking presentation data (for example, video images from a movie, audio from a podcast), determining that the content includes an untrue assertion (for example, “the United States only has 48 states”) and automatically correcting the presentation so that the untrue assertion is corrected (for example, replacing an incorrect video caption with “the United States has 50 states as of early 2021”).

### BACKGROUND

The present invention relates generally to the field of computer data that is used to generate audiovisual presentations (for example, a popular movie streamed to users over a streaming service) and audio presentations (that is, presentations that are substantially audio only, such as an audio podcast distributed to listeners over a computer network).

U.S. Patent Application Publication 2016/0173814 (“Fonseca”) states as follows: “Particular embodiments provide supplemental content that may be related to video content that a user is watching. A segment of closed-caption text from closed-captions for the video content is determined. A first set of information from the segment of closed-caption text, such as terms may be extracted. Particular embodiments use an external source that can be determined from a set of external sources. To determine the supplemental content, particular embodiments may extract a second set of information from the external source. Because the external source may be more robust and include more text than the segment of closed-caption text, the second set of information may include terms that better represent the segment of closed-caption text. Particular embodiments thus use the second set of information to determine supplemental content for the video content, and can provide the supplemental content to a user watching the video content.”

### SUMMARY

According to an aspect of the present invention, there is a method, computer program product and/or system that performs the following operations (not necessarily in the following order): (i) receiving an initial version of an audiovisual presentation data set corresponding to an audiovisual presentation in human understandable form and format that includes video images and an audio portion; (ii) parsing a first piece of natural language text that is presented in video images of the audiovisual presentation; (iii) determining that the first piece of natural language text represents a first factual assertion; (iv) determining that the first factual assertion is untrue; (v) determining a second piece of natural language text that corrects the untrue factual assertion inhering in the first piece of natural language text; and (vi) generating a corrected version of the audiovisual presentation data set that includes, in video images, the second piece of natural language text in place of the first piece of natural language text.

According to an aspect of the present invention, there is a method, computer program product and/or system that performs the following operations (not necessarily in the following order): (i) receiving an initial version of an audiovisual presentation data set corresponding to an audiovisual presentation in human understandable form and format that includes video images and an audio portion; (ii) parsing a first piece of natural language text that is presented in the audio portion of the audiovisual presentation; (iii) determining that the first piece of natural language text represents a first factual assertion; (iv) determining that the first factual assertion is untrue; (v) determining a second piece of natural language text that corrects the untrue factual assertion inhering in the first piece of natural language text; and (iv) generating a corrected version of the audiovisual presentation data set that includes, in the audio portion, the second piece of natural language text in place of the first piece of natural language text.

According to an aspect of the present invention, there is a method, computer program product and/or system that performs the following operations (not necessarily in the following order): (i) receiving an initial version of an audio presentation data set corresponding to an audio presentation in human understandable form and format that includes an audio portion; (ii) parsing a first piece of natural language text that is presented in the audio portion of the audio presentation; (iii) determining that the first piece of natural language text represents a first factual assertion; (iv) determining that the first factual assertion is untrue; (v) determining a second piece of natural language text that corrects the untrue factual assertion inhering in the first piece of natural language text; and (vi) generating a corrected version of the audio presentation data set that includes, in the audio portion, the second piece of natural language text in place of the first piece of natural language text.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4A is a screenshot view 400a generated by the first embodiment system prior to caption correction;

FIG. 4B is another screenshot view 400b generated by the first embodiment system after a caption correction according to the present invention;

FIG. 4C is another screenshot view 400c generated by the first embodiment system prior to caption correction;

FIG. 4D is another screenshot view 400d generated by the first embodiment system after a caption correction according to the present invention;

FIG. 4E is another screenshot view 400e generated by the first embodiment system prior to caption correction;

FIG. 4F is another screenshot view 400f generated by the first embodiment system after a caption correction according to the present invention;

FIG. 5 is a diagram helpful in understanding various embodiments of the present invention; and

FIG. 6 is a flowchart according to a second embodiment of a method according to the present invention.

### DETAILED DESCRIPTION

Some embodiments are directed to computer technology for taking presentation data (for example, video images from a movie, audio from a podcast), determining that the content includes an untrue assertion (for example, “the United States only has 48 states”) and automatically correcting the presentation so that the untrue assertion is corrected (for example, replacing an incorrect video caption with “the United States has 50 states as of early 2021”). This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

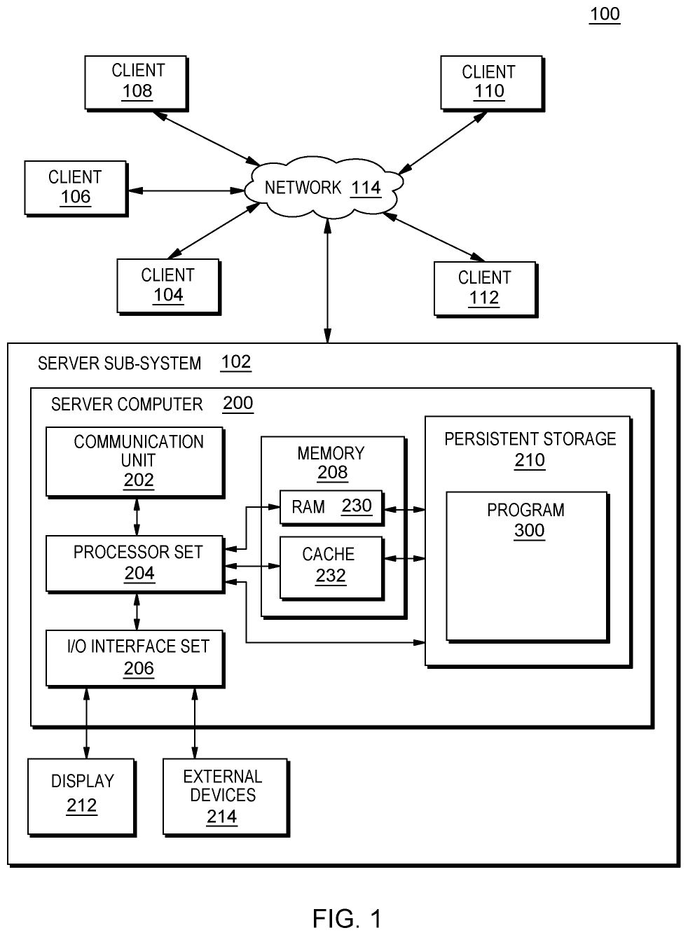

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

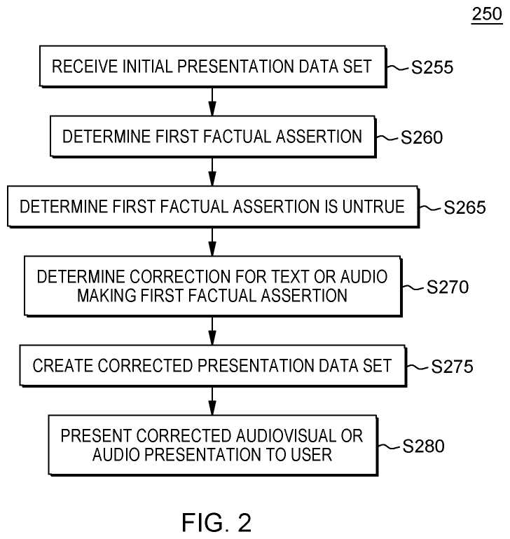

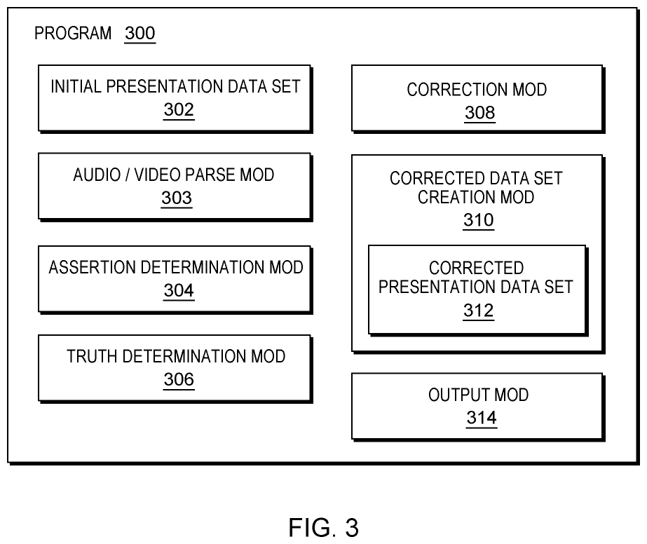

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

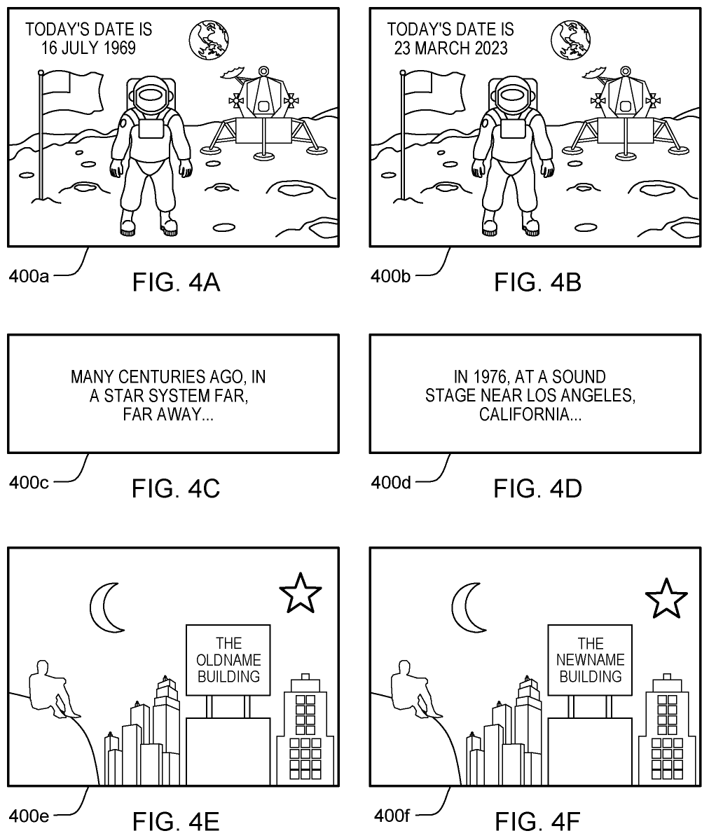

Processing begins at operation S255, where initial presentation data set 302 is received through network 114 from client subsystem 104. Subsystem 104, in this example, serves the data for movies for end user. In this example of the method of the flowchart 250, three movies will be used as sub-examples as follows: (i) a movie of the moon landing of 16 Jul. 1969 (see screenshot 400a of FIG. 4A); (ii) a science fiction fantasy movie, released in 1977, that opens with a text crawl (see screenshot 400c of FIG. 4C); and (iii) a user video submitted to an internet video streaming service, which video shows the user sitting on a hillside overlooking the skyline of the big city as a backdrop (see screenshot 400e of FIG. 4E). In this example, each of these three (3) movies is downloaded in its entirety by program 300 to computer 200. In another example, the presentation data set may be a portion of a larger streaming data set that is streamed, ultimately, to end user(s), such as the end user that owns and controls a smart phone in the form of client subsystem 106. While this example deals with audiovisual presentations, such as movies, home videos and television programs, alternatively, some embodiments involve audio only presentations, such as podcasts, audio books, recorded educational lectures and the like. While this example deals with natural language that appears as visually displayed text (see, for example, screenshots 400a, 400c and 400e), alternatively, some embodiments involve natural language that appears in the audio portion of the presentation.

Processing proceeds to operation S260, where assertion determination mod 304 determines that a first factual assertion exists in the natural language text. More specifically, mod 304 calls on audio/video parse mod 303 to parse a first piece of natural language text out of the initial presentation data set 302. Alternatively, this first piece of natural language text may take the form of sound as it “appears” in the audiovisual presentation. More specifically, for the three sub-examples of FIGS. 4A, 4C and 4E, this first natural language text is as follows: (i) for screenshot 400a, “TODAY'S DATE IS 16 Jul. 1969”; (ii) for screenshot 400c, “Many centuries ago, in a star system far, far away . . . ”; and (iii) for screenshot 400e, “THE OLDNAME BUILDING.”

Processing proceeds to operation S265, where truth determination mod 306 determines that the first factual assertion is untrue. For purposes of this document, a factual assertion that may be true or false and/or believed by some to be true and others to be false. For example, the phrase “The Oldname Building” is not a factual assertion because, taken in isolation of other words and other types of context, the idea of naming a building “Oldname” is neither true nor false. Determination of the factual assertion from the corresponding natural language text may include a consideration of context that is above and beyond the first natural language text itself. For the presently discussed sub-examples of FIGS. 4A, 4C and 4E, the factual assertions are determined to be as follows: (i) for screenshot 400a, the factual assertion is that the date that the user is watching the video is 16 Jul. 1969; (ii) for screenshot 400c, the factual assertion is that the events being shown in the video images occurred hundreds of years ago and far from planet Earth; and (iii) for screenshot 400e, the factual assertion is that the large building dominating the center of the city skyline in the video images is called “The Oldname Building.” To discuss the extraction of the factual assertion for sub-example (iii), the machine logic of the assertion determination mod is programmed to understand that the words appearing in a large sign on top of a large building in a downtown area will typically reflect the name of the building. It is this context info that turns the non-assertion form text into a factual assertion that may be evaluated as a true or false statement that is subject to correction for being untrue.

Processing proceeds to operation S270, where correction mod 308 determines a second piece of natural language text that corrects the untrue factual assertion inhering in the first piece of natural language text. In the three sub-examples currently under discussion, the corrected texts are as follows: (i) for screenshot 400a, “TODAY'S DATE IS 23 Mar. 2023” (because that is the date that the user at client subsystem 106 has requested to watch the archival news footage of the first moon landing); (ii) for screenshot 400c, “In 1976, at a sound stage near Los Angeles, Calif. . . . ” (because that is when and where the events in the video images of the movie actually took place); and (iii) for screenshot 400e, “THE NEWNAME BUILDING” (because the building changed its sponsorship and name after the home video was shot).

In this embodiment, operations S265 and S270 include the following sub-operations: (i) generating a first query designed to check the veracity of the first factual assertion; (ii) querying a database using the first query; and (iii) receiving first query results indicating that the first factual assertion is untrue and information indicating how to correct the first factual assertion into a suitable replacement factual assertion.

Processing proceeds to operation S275, where corrected data set creation mod 310 generating a corrected version of the audiovisual presentation data set 312 that includes, in video images, the second piece of natural language text in place of the first piece of natural language text. The presentation of screenshot 400a is corrected to the presentation shown in screenshot 400b of FIG. 4B. The presentation of screenshot 400c is corrected to the presentation shown in screenshot 400d of FIG. 4D. The presentation of screenshot 400e is corrected to the presentation shown in screenshot 400f of FIG. 4F.

Processing proceeds to operation S280, where output mod 314 sends the corrected version of the audiovisual presentation data set over a communication network and to a set of user device(s) for presentation to human user(s). In this example, the user who has requested the three (3) audiovisual presentation sub-examples, is the person who owns, controls and uses a smartphone in the form of client subsystem 106.

Some embodiments create a content schema data structure that represents the subject matter of the audiovisual presentation, with the content schema data structured to include: (i) a plurality of nodes respectively corresponding to a plurality of entities included or involved in the audiovisual presentation, and (ii) a plurality of edges that represent connections among and between the plurality of nodes. This may be further discussed in the following sub-section of this Detailed Description section.

### III. Further Comments and/or Embodiments

A method for automatically updating media (for example, video) according to an embodiment of the present invention includes the following operations (not necessarily in the following order): (i) creates a content schema representing entities present in a media file (for example, a video file); (ii) utilizes a combination of metadata analysis, visual recognition, optical character recognition, speech-to-text, and NLP (natural language processing)/entity extraction; (iii) searches a database (for example, a web search engine database) for updated (for example, new) information relating to the entities present in the media file; and (iv) updates the media file to include the updated information, using video annotations, subtitles, voiceover, and/or images.

Some embodiments of the present invention may include one, or more, of the following operations, features, characteristics and/or advantages: (i) the update process is driven by factors that are intrinsic to the media content (stale URL (uniform resource locator) showcased in the video including the company CEO (chief executive officer) who is mentioned in the audio, but has since changed, etc.); (ii) analyzes the actual “facts” presented in a video; (iii) searches the internet to gather updates to the facts (whether in textual, image, audio or other formats) and then dynamically updates the video with the new content in an automated fashion; (iv) is capable of understanding the “facts” in a video format; (v) is capable of determining that the content in a video is obsolete and needs to be updated; (vi) gathers objective reasons why the content should be updated by understanding the content (image, text and audio analysis); (vii) validates whether the information gathered is still accurate, and performs updating accordingly; (viii) can independently analyze a video and determine, for example: (a) the video contains an interview with the CEO of an automobile company where by searching the internet and using AI (artificial intelligence) techniques, concludes that the CEO has retired, and (b) has the ability to insert an annotation in the video alerting the viewer to the fact that the CEO has retired; and/or (ix) prevents the content from “being stale” (or inaccurate), which is an objective assessment based on the state of the information carried by the content.

Some embodiments of the present invention may include one, or more, of the following operations, features, characteristics and/or advantages: (i) uses “speech to text”+“visual recognition” to apply to a broader use case; (ii) is not limited to textual content; (iii) has the ability to analyze audio, video and text using a variety of techniques to generate a holistic understanding of the facts presented in a video; (iv) does not require identification of a hyperlinked source of textual content source from the video; (v) utilizes an internet crawl to find all potential sources of content; (vi) uses dates of search results and the count of relevant and more recent search results to make a decision on whether the video content needs an update; (vii) does not just use text comparison between the text in the video and the text located at a given source; and/or (viii) has the ability understand facts.

Some embodiments of the present invention may include one, or more, of the following operations, features, characteristics and/or advantages: (i) analyzes the content of posted media itself (as opposed to meta-data or viewer data); (ii) gathers updates to the content of the media and dynamically updates the media with the new content in an automated fashion; and/or (iii) determines if the facts in the media content have changed, and proceeds to update them.

Some embodiments of the present invention recognize the following facts, potential problems and/or potential areas for improvement with respect to the current state of the art: (i) the medium of video and audio has become a major source of communicating information to a potential audience; (ii) businesses, non-profit organizations, and individuals often upload and post video and audio recordings on media sharing web sites; (iii) posted media is often used to disseminate information to consumers, partners, employees, or investors; (iv) information may be company news, business updates, product information, and training; (v) other organizations may post media content such as product reviews, expert opinions, and/or how-to videos; and/or (vi) in addition, other entities may post content for entertainment purposes.

Some embodiments of the present invention recognize the following facts, potential problems and/or potential areas for improvement with respect to the current state of the art: (i) when media such as video and audio clips, podcasts etc. are made available via popular media sharing sites, they remain available in perpetuity; (ii) at the same time, media often contains a “point in time” view of something (for example, a podcast from a financial analyst may contain their view of a company based on information available at that point in time); (iii) a product review video posting may be based on the reviewer's analysis of product features that are known to the reviewer, up to that point in time; and/or (iv) posted media may contain facts and figures such as: (a) the number of employees in a company, (b) the name of the CEO of a company, (c) the value of a company stock, and/or (d) information about a sports record, etc., that are known to be true at the time the media was posted.

Some embodiments of the present invention recognize the following facts, potential problems and/or potential areas for improvement with respect to the current state of the art: (i) after a period of time has elapsed and after the media posting, there can be a change in information contained within the media (for example, a product may get new features that were missing at the time the product review media was posted); (ii) facts can change (for example, the value of a stock of a company can change, or the CEO of a company can change, or a sports record can be broken a few weeks or months after the media was posted) thus makings the information contained in the original media content inaccurate or outdated; and/or (iii) if a viewer accesses such media as described above, the viewer would likely be viewing old, incorrect, and potentially damaging information.

Some embodiments of the present invention recognize the following facts, potential problems and/or potential areas for improvement with respect to the current state of the art: (i) if a media creator wants to be current, they have to actively monitor for changes in facts or information and check if it makes information contained within their posted media outdated or obsolete; (ii) media creators may have to manually update or augment those parts of the media to reflect more up-to-date information; (iii) media creators may have to redo the entire media often; (iv) manual media content updates can be extremely time consuming and inefficient; (v) what is needed is a solution that can automatically and dynamically update posted media to incorporate more up-to-date information and facts; and/or (vi) methods currently used by media creators are manual updates to the media or a recreation of the media.

Some embodiments of the present invention may include one, or more, of the following operations, features, characteristics and/or advantages: (i) uses techniques such as speech to text, optical character recognition, visual recognition, and using data from ingesting sub-titles, meta data analysis (chapter markers, bookmarks) that: (a) identifies the various parts of the media (chapters, topics, sections, etc.), and/or (b) transcribes the posted media (video or audio) to text and, optionally, to a set of images; (ii) uses natural language understanding to parse the textual data and generate a schema using extracted elements such as: (a) categories, (b) entities (person, organization, dates etc.), (c) attributes (names, values), and/or (d) semantic roles (subject, action, object); (iii) uses visual recognition to classify images; and/or (iv) for each part of the media, using the list of elements described above as search parameters, crawls or searches the internet sources (for example, news feeds, other media content, bulletins, company data, etc.): (a) at set intervals after the date the media is/was posted, and/or (b) at the request of the media creator/poster/uploader.

Some embodiments of the present invention may include one, or more, of the following operations, features, characteristics and/or advantages: (i) filters search results based on the most recent date and gathers additional information for the elements; (ii) compares the original list of extracted elements with the elements extracted from the newly gathered information and determines if any part of the media needs to be updated; (iii) if required, performs an update to the media, at the appropriate time within the media, by adding annotations to the video including: (a) adding sub-titles, and/or (b) inserting voice overs or images that contain more current information gathered from the internet; (iv) returns the updated video clip to the creator; (v) posts the updated video clip directly to a media sharing site; and/or (vi) has the ability to: (a) analyze the posted media, (b) gather updated information, and/or (c) dynamically update media in an automated fashion is novel.

Some embodiments of the present invention may include one, or more, of the following operations, features, characteristics and/or advantages: (i) provides a solution that enables organizations to ensure that the audience of their multimedia content is getting the latest and most accurate information; and/or (ii) media sharing websites would derive significant business value from a feature on their site that would allow content producers to update and augment shared media clips whose content has become stale or outdated since the media was posted.

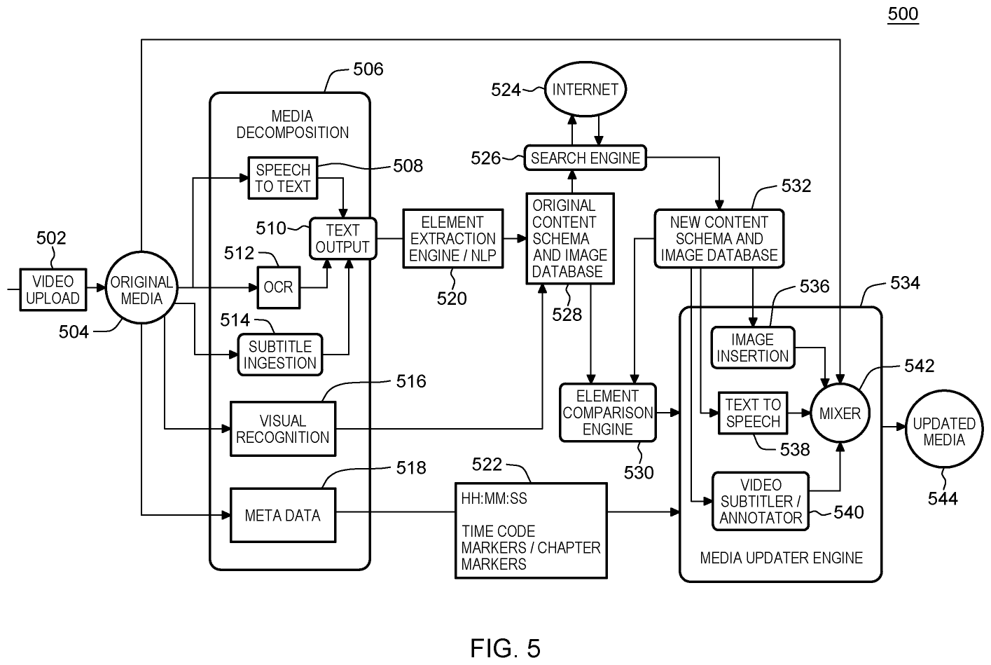

As shown in FIG. 5, diagram 500 includes: video upload block 502; original media block 504; media decomposition block 506; speech to text block 508; text output block 510; OCR (optical character recognition) block 512; subtitle ingestion block 514; visual recognition block 516; meta data block 518; element extraction engine/NLP (natural language processing) block 520; HH:MM:SS time code markers/chapter markers block 522; internet block 524; search engine block 526; original content and image database block 528; element comparison engine 530; new content schema and image database block 532; media updater engine 534; image insertion block 536; text to speech block 538; video subtitler/annotator block 540; muxer 542; and updated media block 544.

According to some embodiments of the present invention, there is a software module running on media-sharing websites or on the workstation of the media creator. The solution consists of six (6) parts that work in the order described in the paragraphs below, with reference to diagram 500 of FIG. 5.

1. Initial Upload Engine (reference block 502 within diagram 500 of FIG. 5): When the media creator uploads a video or audio, they can set up parameters for orchestrating dynamic updates to the video or audio after the posting date. This can include the frequency of updates. It would also allow the creator/publisher to configure a set of parameters for the update process including which news sources to look at and which ones to ignore (maybe based on, for example, political bias). Copyright may also be a parameter including which sources can be used freely without copyright issues (in which case some embodiments of the present invention can take a section and include it in the original clip) otherwise, it would just include a reference list of sites to gather updated information from.

2. Media Decomposition Engine (reference block 506 within diagram 500 of FIG. 5): After the media is uploaded, the invention would do an initial analysis of the media into its various elements. Using techniques such as speech to text, optical character recognition, and using data from ingesting sub-titles, meta data analysis (chapter markers, bookmarks), it would identify the various parts of the media (chapters, topics, sections etc.) and transcribe the posted media (video or audio) to text and, optionally, a set of images.

3. Element Extraction Engine (reference block 520 within diagram 500 of FIG. 5): This module uses natural language understanding to parse the textual data and generate a schema using extracted elements such as categories, entities (person, organization, dates etc.), attributes (names, values), and semantic roles (subject, action, object). It further uses visual recognition to classify and tag the images. This list of elements and images will be stored in a database.

4. Data Search Engine (reference block 526 within diagram 500 of FIG. 5): For each part of the media, at set intervals or at the ad-hoc request of the media creator/poster/uploader, some embodiments of the present invention will use the list of elements generated in the previous operations to crawl the list of configured sources including but not limited to news feeds, other media content, bulletins, company data, etc. The crawled data is also analyzed and decomposed into a list of elements stored in a second database.

5. Data comparison engine (reference block 530 within diagram 500 of FIG. 5): The elements of the posted media would be compared with the elements of the data gathered from internet sources. This will generate a list of updates to be made to the original media.

6. Media Updater Engine (reference block 534 within diagram 500 of FIG. 5): The media updater engine would pick up the text, images and audio that needs to be inserted in the original media to update it. Using the time code from the original media, it will perform an update to the original media by adding annotations to the video, adding sub-titles, inserting voice overs or images that contain more current information gathered from the internet, at the appropriate time indices within the original media. The updated media will then be made available for viewing.

Some embodiments of the present invention may include one, or more, of the following operations, features, characteristics and/or advantages: (i) replaces video content that is outdated; (ii) is not solely dependent on closed-caption text; (iii) analyzes audio, video and text using a variety of techniques described herein to generate a holistic understanding of the facts presented in a video; (iv) the analysis of the foregoing item is performed on a periodic basis and determines if the facts presented are no longer valid since the video was posted; (v) if it determines so, it replaces or enhances the content with more current facts; (vi) the obsolete content sections continue to be enhanced with current facts; and/or (vii) the content viewed yesterday may be partially different from today if some facts have changed.

Some embodiments of the present invention may include one, or more, of the following operations, features, characteristics and/or advantages: (i) the extraction of the first piece of information includes at least one of the following: (a) metadata analysis, (b) visual recognition, (c) optical character recognition, (d) speech-to-text, and/or (e) NLP (natural language parsing)/entity extraction; (ii) the extraction of the first piece of information includes creation of a content schema that includes: (a) a plurality of nodes respectively corresponding to a plurality of entities included or involved in the audio and/or visual presentation, and/or (b) a plurality of edges that represent connections among and between the plurality of nodes; (iii) the first piece of information relates to a first entity corresponding to a first node of the plurality of nodes; (iv) the creation of the content schema includes at least includes at least: (a) metadata analysis, (b) visual recognition, (c) optical character recognition, (d) speech-to-text, and/or (e) NLP (natural language parsing)/entity extraction; (v) the creation of the content schema includes at least metadata analysis; and/or (vi) the creation of the content schema includes at least includes at least: visual recognition.

Some embodiments of the present invention may include one, or more, of the following operations, features, characteristics and/or advantages: (i) the creation of the content schema includes at least includes at least: optical character recognition; (ii) the creation of the content schema includes at least includes at least: speech-to-text; (iii) the creation of the content schema includes at least includes at least NLP (natural language parsing)/entity extraction; (iv) the database is a web search engine database; (v) the second content portion presents the second piece of information in a manner that includes video annotations; (vi) the second content portion presents the second piece of information in a manner that includes subtitles; (vii) the second content portion presents the second piece of information in a manner that includes voiceover; and/or (viii) the second content portion presents the second piece of information in a manner that includes images.

Some embodiments of the present invention may include one, or more, of the following operations, features, characteristics and/or advantages: (i) the system process will proceed only when the assertion is false; (ii) the system process determines if the assertion is false, and if false, corrects the facts; (iii) has the ability to periodically (and automatically) test and correct false assertions in a clip; and/or (iv) has the ability to edit and replace sections of a clip such that no assertions of the edited clip is false.

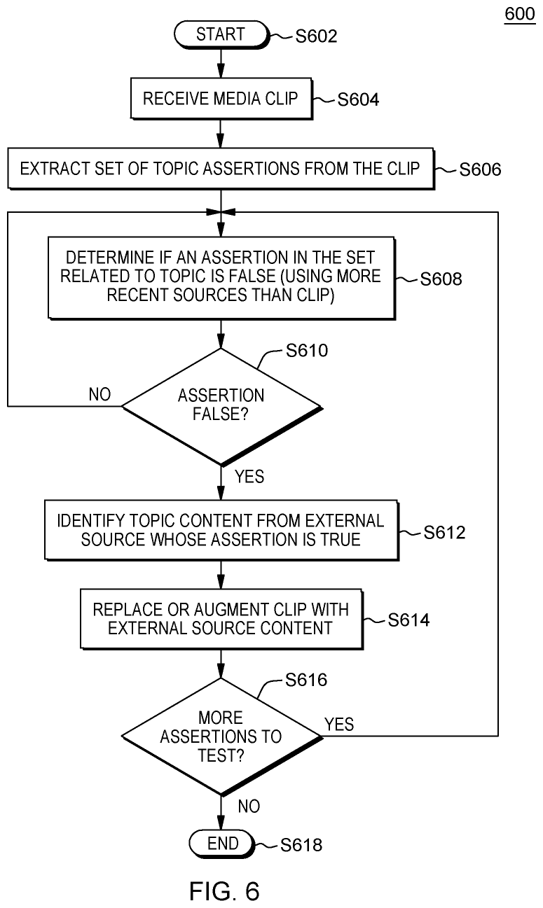

As shown in FIG. 6, flowchart 600 includes the following method operations: start block S602; receive media clip block S604; extract set of topic assertions from the clip block S606; determine if an assertion in the set related to topic is false (using more recent sources than clip) block S608; assertion false decision block, Y/N, S610; identify topic content from external source whose assertion is true block S612; replace or augment clip with external source content block S614; more assertions to test decision block, Y/N, S616; and end block S618.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer implemented method (CIM) comprising:
receiving an initial version of an audiovisual presentation data set corresponding to an audiovisual presentation in human understandable form and format that includes video images and an audio portion;
parsing a first piece of natural language text that is presented in video images of the audiovisual presentation;
determining that the first piece of natural language text represents a first factual assertion;
determining that the first factual assertion is untrue;
determining a second piece of natural language text that corrects the untrue factual assertion inhering in the first piece of natural language text; and
generating a corrected version of the audiovisual presentation data set that includes, in video images, the second piece of natural language text in place of the first piece of natural language text.

2. The CIM of claim 1 further comprising:
sending the corrected version of the audiovisual presentation data set over a communication network and to a set of user device(s) for presentation to human user(s).

3. The CIM of claim 1 wherein the parsing of a first piece of natural language text includes at least the following technique: metadata analysis.

4. The CIM of claim 1 wherein the parsing of a first piece of natural language text includes at least the following technique: visual recognition.

5. The CIM of claim 1 wherein the parsing of a first piece of natural language text includes at least the following technique: optical character recognition.

6. The CIM of claim 1 wherein the parsing of a first piece of natural language text includes at least the following technique: speech-to-text.

7. The CIM of claim 1 wherein the parsing of a first piece of natural language text includes at least the following technique: NLP (natural language parsing)/entity extraction.

8. The CIM of claim 1 further comprising:
creating a content schema data structure that represents the subject matter of the audiovisual presentation, with the content schema data structure includes: (i) a plurality of nodes respectively corresponding to a plurality of entities included or involved in the audiovisual presentation, and (ii) a plurality of edges that represent connections among and between the plurality of nodes.

9. The CIM of claim 8 wherein the untrue factual assertion relates to a first entity corresponding to a first node of the plurality of nodes.

10. The CIM of claim 8 wherein the creation of the content schema includes at least includes at least: metadata analysis.

11. The CIM of claim 8 wherein the creation of the content schema includes at least includes at least: visual recognition.

12. The CIM of claim 8 wherein the creation of the content schema includes at least includes at least: optical character recognition.

13. The CIM of claim 8 wherein the creation of the content schema includes at least includes at least: speech-to-text.

14. The CIM of claim 8 wherein the creation of the content schema includes at least includes at least: NLP (natural language parsing)/entity extraction.

15. The CIM of claim 1 wherein the determination that the first factual assertion is untrue and the determination of the second piece of natural language text includes:
generating a first query designed to check the veracity of the first factual assertion;
querying a database using the first query; and
receiving first query results indicating that the first factual assertion is untrue and information indicating how to correct the first factual assertion into a suitable replacement factual assertion.

16. A computer implemented method (CIM) comprising:
receiving an initial version of an audiovisual presentation data set corresponding to an audiovisual presentation in human understandable form and format that includes video images and an audio portion;
parsing a first piece of natural language text that is presented in the audio portion of the audiovisual presentation;
determining that the first piece of natural language text represents a first factual assertion;
determining that the first factual assertion is untrue;
determining a second piece of natural language text that corrects the untrue factual assertion inhering in the first piece of natural language text; and
generating a corrected version of the audiovisual presentation data set that includes, in the audio portion, the second piece of natural language text in place of the first piece of natural language text.

17. The CIM of claim 16 further comprising:
sending the corrected version of the audiovisual presentation data set over a communication network and to a set of user device(s) for presentation to human user(s).

18. A computer implemented method (CIM) comprising:
receiving an initial version of an audio presentation data set corresponding to an audio presentation in human understandable form and format that includes an audio portion;
parsing a first piece of natural language text that is presented in the audio portion of the audio presentation;
determining that the first piece of natural language text represents a first factual assertion;
determining that the first factual assertion is untrue;
determining a second piece of natural language text that corrects the untrue factual assertion inhering in the first piece of natural language text; and
generating a corrected version of the audio presentation data set that includes, in the audio portion, the second piece of natural language text in place of the first piece of natural language text.

19. The CIM of claim 18 further comprising:
sending the corrected version of the audio presentation data set over a communication network and to a set of user device(s) for presentation to human user(s).
